(19) United States
(12) Patent Application Publication
(10) Pub. No.: US 2018/0145416 A1
(43) Pub. Date: May 24, 2018

(54) DISTRIBUTED ANTENNA FOR MICRO AND NANO TRANSCEIVERS

(71) Applicant: NR, LLC, ALEXANDRIA, VA (US)

(72) Inventors: MARIO CARDULLO, ALEXANDRIA, VA (US); ROB MEAGLEY, ALEXANDRIA, VA (US); JOHN MARTIN, ALEXANDRIA, VA (US)

(21) Appl. No.: 15/442,621

(22) Filed: Feb. 24, 2017

Related U.S. Application Data
(60) Provisional application No. 62/299,187, filed on Feb. 24, 2016.

(51) Int. Cl. H01Q 9/06; H01Q 9/16; H01Q 1/38; B82Y 15/00

(52) U.S. Cl. CPC H01Q 9/065; B82Y 15/00; H01Q 1/38; H01Q 9/16

(57) ABSTRACT

A distributed antennae system for micro or nano transceivers, and method for using same, is disclosed. The antennae individually are of the scale of the micro or nano transceivers. The plurality of antenna and associated transceivers are configured to collectively increase receiving and transmitting gain of electromagnetic (RF, optical) radiation signals.

### CROSS-REFERENCE TO RELATED APPLICATIONS

Provided per USPTO rules by Application Data Sheet

### STATEMENT REGARDING FEDERALLY SPONSORED RESEARCH

Provided per USPTO rules by Application Data Sheet.

### NAMES OF PARTIES TO A JOINT RESEARCH AGREEMENT

Provided per USPTO rules by Application Data Sheet.

### REFERENCE TO SEQUENCE LISTING

Provided per USPTO rules by Application Data Sheet

### STATEMENT REGARDING PRIOR DISCLOSURES BY INVENTOR

Provided per USPTO rules by Application Data Sheet

### BACKGROUND OF THE INVENTION

### Field of the Invention

The invention relates to methods for making and using nano-antennae attached to nanotransceiver devices to enable receipt of, and response to, information transmitted using RF or optical electromagnetic radiation.

### Description of the Related Art

An antenna is generally a transducer device that receives or transmits electromagnetic radiation. The frequency of radiation that may be received or transmitted by an antenna is dependent on the size of the antenna, and the speed of light and the distance that electrons can travel (electron mobility) in the material medium of the antenna. Because electromagnetic waves propagate more slowly in a medium than in free space, the same number of waves will span a greater distance in free space than in the transmission medium, hence the transmission medium is said to have an electrical length that is greater than its physical length. Typically, the electrical length of an antenna is expressed in units of the wavelength (in the antenna medium) corresponding to the resonant frequency of the antenna.

Antennas are typically associated with signals having frequency of about 30 kilohertz (kHz) to about 30 gigahertz (GHz), and may be associated with, for example, longwave AM radio broadcasting, wireless LAN, radars and satellite television broadcasting. In general, the electrical length of an antenna is on the order of the free-space wavelength of the radiation at which the antenna is resonant. For example, a dipole antenna is typically about ¼th the free-space wavelength. Similarly, the physical length of an antenna is on the order of the wavelength in the antenna medium of the radiation at which the antenna is resonant. Given that the wavelength of electromagnetic radiation is shorter in a medium than in free space, the physical length of an antenna is typically shorter than its electrical length.

The smallest RFID reported in the literature or press is the Hitachi 0.05 mm×0.05 mm “super micro RFID tag” device (0.05 mm=5×10⁴ nm). While the device is not nanometer scale in surface dimension, it also reportedly is attached to a 6 mm (6×10⁶ nm) antenna by means of traditional bonding. [http://techonnikkeibp.co.jp/english/News_EN/20070220/127959/].

Virtually all of the RF transceivers employed in RFIDs use discrete antenna.

Many of the antenna are external loop antenna, but dipole antenna are also used. However, in the case where the antenna is integrated with the RF transceiver integrated circuit, the antennae are virtually always single layer spiral design. The integrated device's scale is limited by the size of the antenna which can be incorporated. Thus, while the transceiver integrated circuit can be scaled as rapidly as the commercial CMOS technology, the current state of the art antennae is limited to >=0.05 mm×0.05 mm. See, e.g. Alberto Vargas and Lukas Vojtech (2010). Near Field On Chip RFID Antenna Design, Radio Frequency Identification Fundamentals and Applications Design Methods and Solutions, Cristina Turcu (Ed.), ISBN: 978-953-7619-72-5, Xi Jintiang, et al., J. of Semiconductors, V.30, N.7, July 2009, pp. 075012-1 to -6.

### BRIEF SUMMARY OF THE INVENTION

The invention meets the need for antenna and transceiver device system which is scalable by employing antennae which are of dimensions comparable to the transceiver device, the antennae and device being capable of self assembly, and a plurality of the same devices being able to act as a swarm, so as to significantly increase gain for reception and transmission of electromagnetic signals.

In some embodiments, the transceiver and antenna may be structured from inorganic and organic materials, such as CMOS integrated circuits and metallic wires.

In other embodiments, the devices and antenna may be structured from different classes of materials, such as metamaterials, inorganic and organic materials for CMOS RF transceiver integrated circuit plus an antenna formed from a conductive biological element. In other embodiments, both the transceiver and the antenna may be structured from biological elements.

In other embodiments the transceiver antenna may be comprised of core shell nanoparticles, quantum dots, nanoparticles and nanowires. In other embodiments the transceiver antenna may be comprised of lithographically defined arrays of nanostructures.

In other embodiments the transceiver antenna may be comprised of nanostructures that are self assembled chemically.

In a preferred embodiment, there is provided a micro or nano electromagnetic radiation transceiver comprising circuitry to sense and react to the electromagnetic radiation, and antenna of dimensions similar to the transceiver, and circuitry to communicate with similarly configured transceivers.

In another preferred embodiment, there is provided a swarm of devices to cooperatively sense electromagnetic radiation and constructed with individual dimensions approaching equal to or less than the wavelength of the radiation, in particular, device sizes less than ½ to 1/10 wavelength of the radiation.

In another preferred embodiment, there is provided a nano electromagnetic radiation transceiver comprising circuitry to sense and react to the electromagnetic radiation, a nano antenna of dimensions similar to the transceiver, an antibody attached to the transceiver, and an antigen specific to the antibody attached to the nano antenna, wherein the transceiver and antenna are attached using antibody-antigen binding, and circuitry to communicate with similarly configured transceivers.

In another preferred embodiment, there is provided a network of devices as described herein.

### BRIEF DESCRIPTION OF THE DRAWINGS

FIG. 1. NR (nanoRFID) (a) displays a molecular recognition site (b).

FIG. 2. Antenna (c) displays complimentary molecular recognition site (d).

FIG. 3. Antenna attaches to NR through molecular recognition and self-assembly to form ensemble (e).

FIG. 4, NR displays a nucleation site (f),

FIG. 5. NR displays a nucleation site (f), which subsequently grows antenna (g).

FIG. 6. Ensemble of NR (h) communicating through local network (i) using external signal (j) to drive system.

FIG. 7. Array of cooperative NR (k) acting as a single antenna to receive the signal (l) from a transceiver (m).

FIG. 8 is an illustration of a reader querying a network of nodes with signal processing and internal and external communication

FIG. 9 is an illustration of a solution-based fabrication method.

FIG. 10 is an illustration of a node with an unfolding antenna.

FIG. 11 is an illustration of fabrication of a single transceiver with multiple antennas.

FIG. 12 is an illustration of a reader communicating with a mesh network of nodes, and additional communication with a ring network, and a star network, using different protocols, and different frequencies

FIG. 13 is an illustration of nodes internal communicating by router node with an interface node to a monitoring station attached to a gateway device.

FIG. 14 is an illustration of typical processing related features programmable into the nodes.

FIG. 15 is an illustration of various sizes and shapes of antennas.

FIG. 16 is an illustration of a shell and core embodiment of an antenna.

FIG. 17 is an illustration of various cross-sectional sizes and shapes of antennas.

FIG. 18 is an illustration of various types of antennas: meander, dipole, bowtie, helical, coil, capacitative endcap, inductive attachment, and variations.

### DETAILED DESCRIPTION OF THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Rather, these embodiments are provided so that this disclosure will be thorough and complete, and will fully convey the scope of the invention to those skilled in the art. Like numbers refer to like elements throughout. As used herein the term “and/or” includes any and all combinations of one or more of the associated listed items.

The terminology used herein is for the purpose of describing particular embodiments only and is not intended to limit the full scope of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal subparts. As will be understood by one skilled in the art, a range includes each individual member.

“Scalable” means nanoantenna-nanotransceiver devices made using nano-manufacturing technologies that are the same technologies or technologies that are complimentary to each other so as to provide a method of manufacturing that produces such nanoantenna-nanotransceiver devices in the same process, or in a process that is run to produce the devices at or around the time of deployment.

“Self-assembly” means the use of chemical or biological conjugation process(es) to produce the combined nanoantenna-nanotransceiver (NANT) devices in solution or at or around the site or time of deployment. The term “self assembly” also refers to nanoelectromechanical (NEM) processes or nanochemomechanical (NCM) processes whereby the antenna is attached to the transceiver in a process that puts them in proximity to each individual subunit to be chemically or biologically conjugated or in electrical contact, or unfolded or unfurled from an already attached position on the transceiver in response to an external signal, or as an antenna that unfolded or unfurled and then attached to the transceiver in sequence.

“Swarm” means a plurality, e.g. two or more, of nanoantenna-nanotransceiver devices deployed in a environment, and receiving and transmitting signals between and among themselves and external signal sources. The term “swarm” also means an operational network of connected nanoantenna-nanotransceiver devices.

“Array” refers to a systematic arrangement of individual subcomponents. An example of an array is a matrix of a plurality of individual terahertz or infrared antenna-transceiver devices. Although arrays commonly refer to a matrix in rows and columns, the invention contemplates both an array of regular rows and columns, or a dispersed or solution-based disposition of a plurality of individual terahertz or infrared antenna-transceiver devices in a non-regular, organic matrix. Non-limiting examples of antenna-transceiver device arrays include matrices having a constellation of individual terahertz or infrared antenna-transceiver devices ranging from 5 to 5×10⁶ individual terahertz or infrared antenna-transceiver devices. Specific non-limiting examples range from 2 to 1000 devices, 50 to 100,000 devices, 1000 to 5000 devices, 10 to 100 devices, 500 to 2000 devices, 5 to 50 devices, and combinations thereof.

“Processor” or “image processor” as used in the following claims includes a computer, multiprocessor, CPU, minicomputer, microprocessor or any machine similar to a computer or processor which is capable of processing algorithms.

“Algorithm” means: sequence of steps using computer software, process, software, subroutine, computer program, or methodology.

“Nanodetector” means an antenna structure to harvest photons from free space into the electronic systems, comprising a nanoantenna. This nanodetector may comprise a nanoantenna system or array, coupled by a transmission line to a system to demodulate the RF. At Terahertz frequencies, metal oxide metal diodes and geometric diodes are used in conjunction with nanoantennas. The nanodetector may comprise a rectifier, creating a “rectenna”. An optical, IR or tHz “rectenna” comprises a nanoantenna coupled to a rectifier circuit comprising high performance diodes. See also: http://physicscentral.com/explore/action/nanoantennas.cfm; http://epjam.edp-open.org/articles/epjam/pdf/2015/01/epjam150012.pdf; https://www.fkf.mpg.de/88022/IV_06_08.pdf; https://en.wikipedia.org/wiki/Optical_rectenna; incorporated herein in their entirety

High performance diodes comprise geometric diodes and metal-oxide-metal diodes. See e.g. http://ecee.colorado.edu/˜moddel/QEL/Papers/Zhu 13a.pdf; http://ecee.colorado.edu/˜moddel/QEL/Papers/Zhul3b.pdf; http://iopscience.iop.org/article/10.1070/QE 1975v004n10ABEH011737; http://ecee.colorado.edu/˜moddel/QEL/Papers/Grover11a.pdf; incorporated herein in their entirety.

Nanodetector may also refer to a semiconductor sensor device that uses an electromagnetic or photoelectric mechanism to detect terahertz and infrared signals by causing electrons within the semiconductor to transition from the valence band to the conduction band, or more simply a device that captures terahertz and infrared signals and converts it to electrical signals. Examples within the scope of the present invention include a terahertz nanodetector, a short-wave infrared nanodetector (SWIR), a medium-wave infrared nanodetector (MWIR), and a long-wave infrared nanodetector (LWIR).

Non-limiting examples within the scope of the invention of the short-wave infrared nanodetector include a detector consisting of an InGaAs (Indium Gallium Arsinide) detector, a quantum dot film detector, a HgCdTe (Mercury Cadmium Tellurium) detector, a Strained Layer Superlattice (SLS) detector, a PbSe (Lead Selenium) detector, and devices having a combination thereof. Non-limiting examples within the scope of the invention of the medium-wave infrared nanodetector include a detector consisting of an nBn (N-type Barrier N-type) detector, an InSb (Indium Tin) detector, a quantum dot film detector, a HgCdTe (Mercury Cadmium Tellurium) detector, a Strained Layer Superlattice (SLS) detector, a PbSe (Lead Selenium) detector, and devices having a combination thereof. Non-limiting examples within the scope of the invention of the long-wave infrared nanodetector include a HgCdTe (Mercury Cadmium Tellurium) detector, a Strained Layer Superlattice (SLS) detector, and devices having a combination thereof. Non-limiting examples within the scope of the invention of the terahertz-wavelength nanodetector include a CMOS (Complementary Metal Oxide Semiconductor) detector, a quantum dot film detector, and devices having a combination thereof.

“Charge-coupled device” (CCD) as used herein is a device for the movement of electrical charge, usually from within the device to an area where the charge can be manipulated, for example conversion into a digital value. This is achieved by “shifting” the signals between stages within the device one at a time. CCDs move charge between capacitive bins in the device, with the shift allowing for the transfer of charge between bins.

“Read out integrated circuit” (ROIC) refers to a multiplexer circuit that is required for use with an IR sensor due to the exotic materials required in the IR sensor/nanodetector. These IR sensor materials, HgCdTe, INSb, InGaAs, VOx, etc., must be paired with silicon CMOS to provide the connection to the transceiver circuitry.

“Field Programmable Gate Array” (FPGA) refers to an integrated circuit that is custom configured using hardware description language. FPGAs contain an array of programmable logic blocks, and a hierarchy of reconfigurable interconnects that allow the blocks to be “wired together”, like many logic gates that can be inter-wired in different configurations. Logic blocks can be configured to perform complex combinational functions, or merely simple logic gates like AND and XOR. In most FPGAs, logic blocks also include memory elements, which may be simple flip-flops or more complete blocks of memory.

“Application Specific Integrated Circuit” (ASIC) refers to an integrated circuit that is pre-configured in its logic architecture to perform a specific function, and is not reconfigurable.

“Digital Signal Processing” and/or “Digital Signal Processor” (DSP) refers to software programming instructions executed on a specialized microprocessor that is optimized for performing software programming instructions used to execute digital signal processing algorithms. Non-limiting examples of the functions of such algorithms include converting analog to digital, performing required mathematical processes, and detecting and correcting digital electronic transmissions. Specific DSP tools include MATLAB® and SIMULINK® for providing algorithms, applications and scopes for designing, simulating and analyzing signal processing for the invention, including designing and implementing any embedded code, software defined logic architectures, FIR, IIR, multirate, multistage and adaptive filters, streaming signals from variables, data files, and network devices. Software, like MATLAB® etc., is contemplated for use as either or both a DSP software hardware-substitute of FPGAs and/or ASICs, adjuncts for FPGAs and ASICs, and/or control software for FPGAs and ASICs.

FPGAs, ASICs, and DSPs are all contemplated as within the scope of the invention for receiving, processing, and transmitting terahertz and infrared signals, as well as calibrating the non-uniform output of IR nanodetectors to provide corrected data to be transmitted and re-transmitted.

“CMOS” refers to complementary metal oxide semiconductor technology which uses a series of layering and etching steps to create three-dimensional logic gates and other functional circuits on an integrated circuit chip.

“Nanotransceiver” refers to a nano scale monolithic integrated circuit that includes a substrate, a set of analog subcircuits forming a receiver, and a set of analog subcircuits forming a transmitter. The receiver includes receiver RF electronics for converting terahertz or IR signals to baseband or an intermediate frequency (IF) signal for further modulation processing. The transmitter includes a transmitter front end and an amplifier. The receiver and transmitter are each in a configuration requiring standard mixers for local oscillator (LO) signals. In some embodiments, this includes phase-locked loop (PLL) synthesizers, and optionally voltage-controlled oscillators (VCO) and phase detectors. One or more IF filters may also be in the receiver and/or transmitter electronics. Baseband converting logic, interface logic, processing logic, as well as analog-digital converters (ADC) are also contemplated as within the receiver and/or transmitter electronics. Processing logic also includes system registers, receiver and transmitter registers, control registers, and address registers.

“Nanotransceiver Self-assembly Interface” (NSI) refers to transceiver interfaces that are chemically, biologically, or mechanically modified to form a connection with a nanoantenna. Chemical substrate paired surfaces, biological conjugate paired surfaces, or nanoelectromechanical (NEM) paired surfaces allow the combination or connection of the nantransceiver to the nanoantenna, or through mixing of a solution of nanotransceivers with a nanoantennae, as a mechanism for constructing the nanotransceiver-antenna devices.

Nanofabrication techniques for producing the antenna structures, the RF components of the transceiver, as well as aspects of the transceiver, include conventional semiconductor methods such as CMOS, photolithography and e-beam lithography. Additional methods will depend on the organic or inorganic materials selected, including sputter deposition, electron beam evaporation, thermal evaporation, or chemical vapor deposition of either metals or alloys.

The substrate may be formed from silicon, fluorocarbon polymer, Teflon®, Teflon AF®, polyimide, polyamide, gallium arsenide, indium phosphide, and silicon carbide to name a few. Active devices will be formed utilizing conventional semiconductor processing equipment. Other substrate materials can also be utilized, depending on the particular application in which the array will be used. For example various glasses, aluminum oxide and other inorganic dielectrics can be utilized. In addition, metals such as aluminum and tantalum that electrochemically form oxides, such as anodized aluminum or tantalum, can be utilized. Those applications utilizing non-semiconductor substrates, active devices can also be formed on these materials utilizing techniques such as amorphous silicon or polysilicon thin film transistor (TFT) processes or processes used to produce organic or polymer based active devices.

Conductive materials for coating the antenna or aspects of the RF circuitry include polyaniline, polypyrrole, pentacene, thiophene compounds, or conductive inks, may utilize any of the techniques used to create thin organic films. For example, screen printing, spin coating, dip coating, spray coating, ink jet deposition and in some cases, as with PEDOT, thermal evaporation are techniques that may be used.

Biological materials for producing the antennas such as polynucleic acids (DNA, RNA, and modified nucelic acids), polypeptides, and modified biological polymers may be used as a conductive and/or structural component of the antenna. Creating nanofibers from biological polymers may provide structures with varying electronic or conductive characteristics.

Coatings including gold and other conductive metals, as well as conductive polymer coatings such as polyanilines, polypyrrols, polythiophenes, and conductive polymer or metal fibers such as may be combined with and/or added to the surface of such biological fibers to create the nano-antenna.

The relationship between frequency and wavelength is given by:

frequency*wavelength=speed of light

Thus, for example where a nanoantenna-nanotransceiver device is operating in the terahertz range, the resulting wavelength for a 1 THz signal will be 299,792.458 nm. A 100 THz signal results in a 2997 nm wavelength. Thus, where the antenna is 1/10th the size of the wavelength, this would require a 299 nm antenna and where the antenna is 1/100th, the length of the antenna for a 100 THz signal would be 29.97 nm. Accordingly, the range of signal for antennas starting at 2.9 nm ( 1/100th) or 29.97 nm ( 1/10th) would be up to 1000 THz. It is contemplated that wavelengths comprising 200 THz, 300 THz, 400 THz, 500 THz, 600 THz, 700 THz, 800 THz, 900 THz, and values therebetween are within the scope of the invention.

Preferred embodiments also include antenna to wavelength ratios comprising 1/2 (e.g. antenna is 1/2 wavelength), 1/3, 1/4, 1/6, 1/8, 1/10, 1/12, 1/15, 1/16, 1/20, 1/24, 1/32, 1/40, 1/50, 1/72, 1/100, and ranges containing combinations of the above ratios. In a specific example, a 1/40 ratio provides a 20 nm IR antenna. In another example, a 1/100 ratio provides an 8 nm IR antenna.

The transceiver device may be fabricated using advanced CMOS RF processing technology (e.g., 20 nm or 22 nm technology node as defined in the International Semiconductory Technology Roadmap) using SOI substrates.

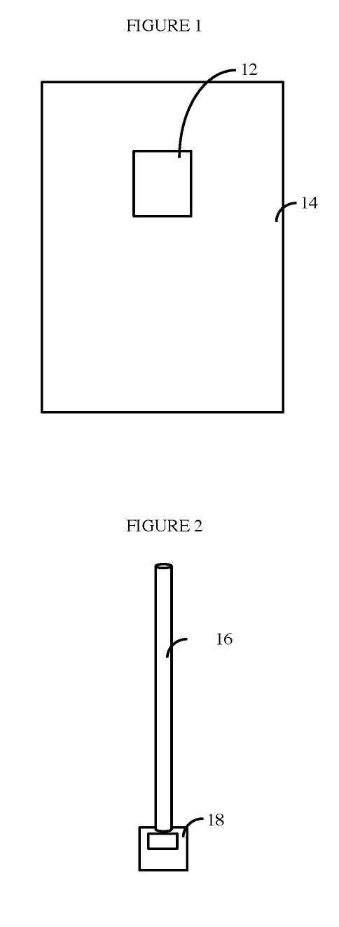

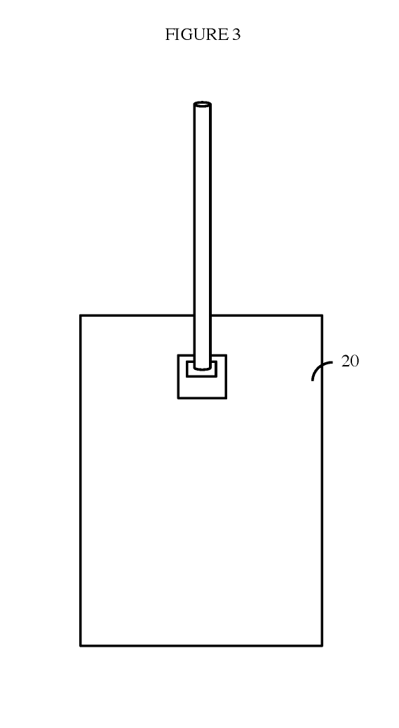

Referring now to the FIGURES, FIG. 1 illustrates a nano-RFID (nano-tranceiver) 14 displays a molecular recognition site 12 where an antenna will be deployed. FIG. 2 illustrates how Antenna 16 displays complimentary molecular recognition site 18. FIG. 3 illustrates how Antenna attaches to Nano-RFID through molecular recognition and self-assembly to form ensemble 20.

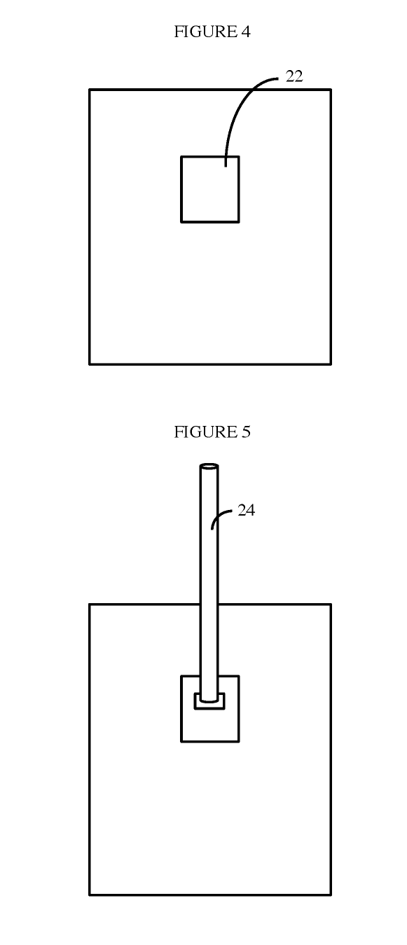

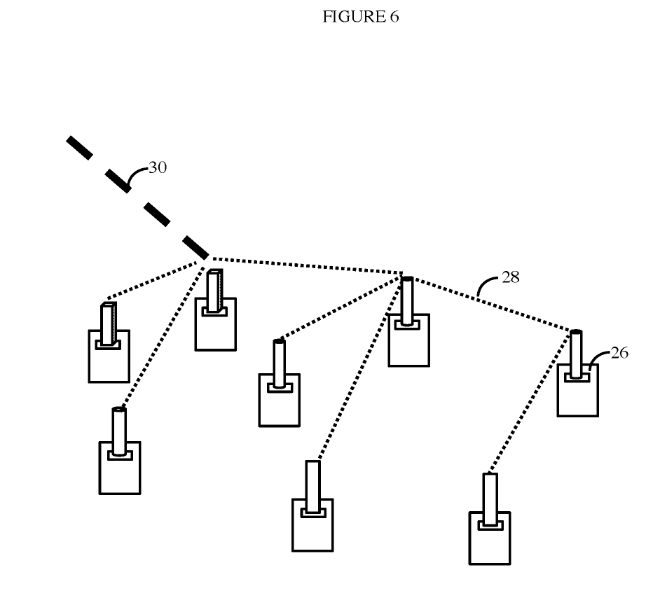

Referring now to FIG. 4, Nano-RFID displays a nucleation site 22, and FIG. 5 illustrates how the Nano-RFID displays a nucleation site which subsequently grows antenna 24.

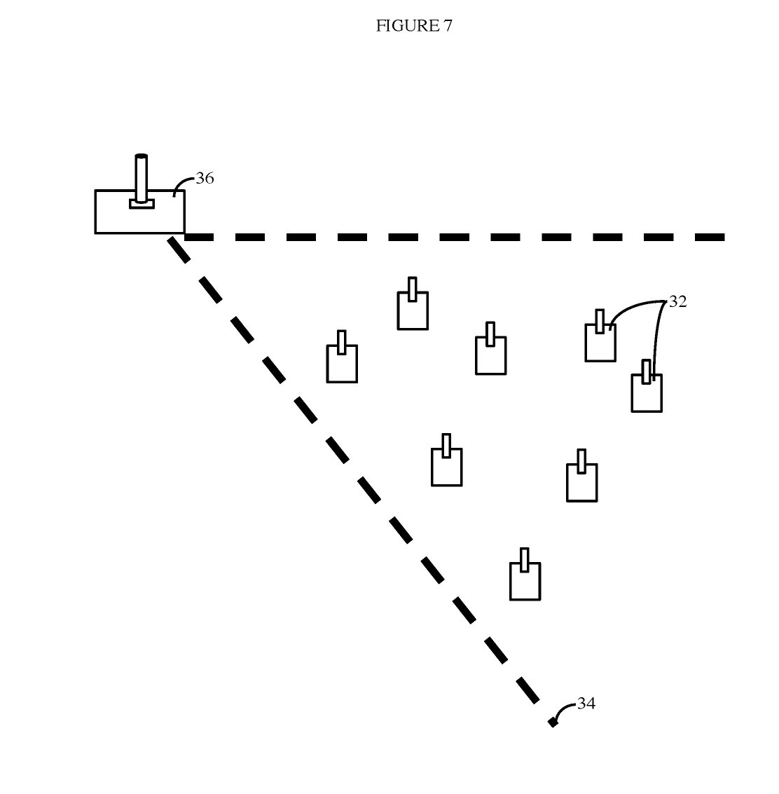

Referring now to FIG. 6, there is shown an Ensemble of Nano-RFID 26 communicating through local network 28 using external signal 30 to drive the system.

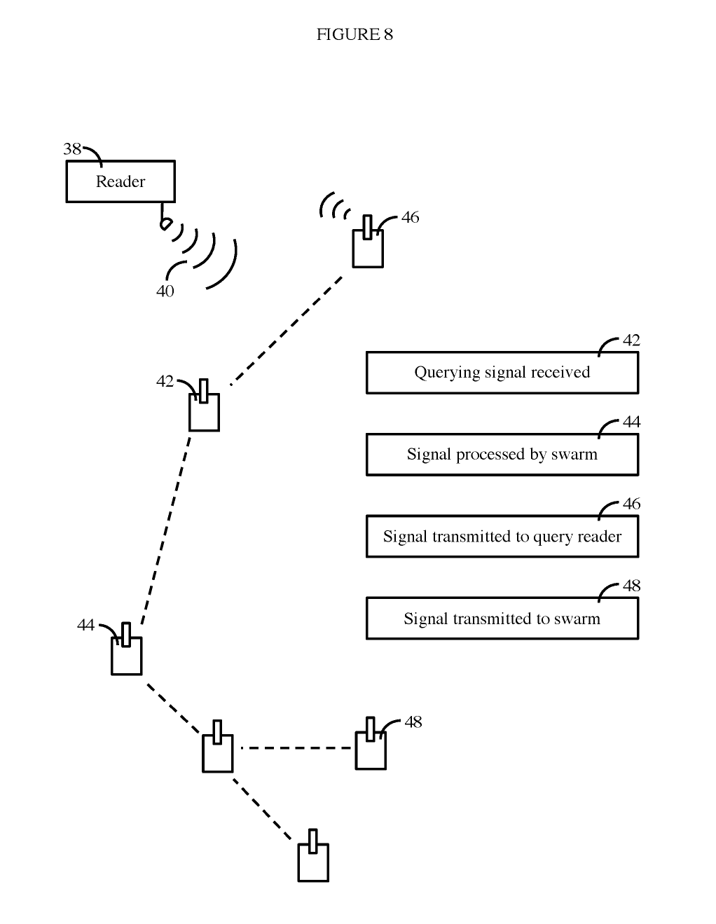

Referring now to FIG. 7, there is shown an Array of cooperative Nano-RFID 32 acting as a single antenna to receive the signal 34 from a transceiver 36.

The transceiver device is designed so that electromagnetic signal can be received directly from an external source, or received from an adjacent companion device which retransmits signal which it has received (i.e., two units in the plurality of devices exchanging and amplifying the signal. Once the querying signal is received and understood by the swarm (plurality of devices), the transceiver transmits its information to the querying reader, and to the adjacent swarm devices, which also transmit the information.

The transceiver device, as part of the fabrication process, carries a selected antigen associated with the device antenna connection. Antenna units, which may be constructed from nanowires, carbon nanotubes, or biological conductors, carry an associated antibody compatible with the transceiver device antigen.

Assembly of the transceiver device and the antenna is achieved by exposing the transceiver devices to carrier fluid containing the antennae units. The resulting self assembled transceiver/antenna units are then deployed as desired.

Referring to FIG. 9, a solution of transceivers 50 is combined with a solution of antennas 52 to produce a plurality of combined nano-antenna transceiver devices 54.

In the instance where the receiving host already contains a structure suitable for acting as the antenna, the transceiver device is constructed with the self assembly component compatible with the anticipated host antenna.

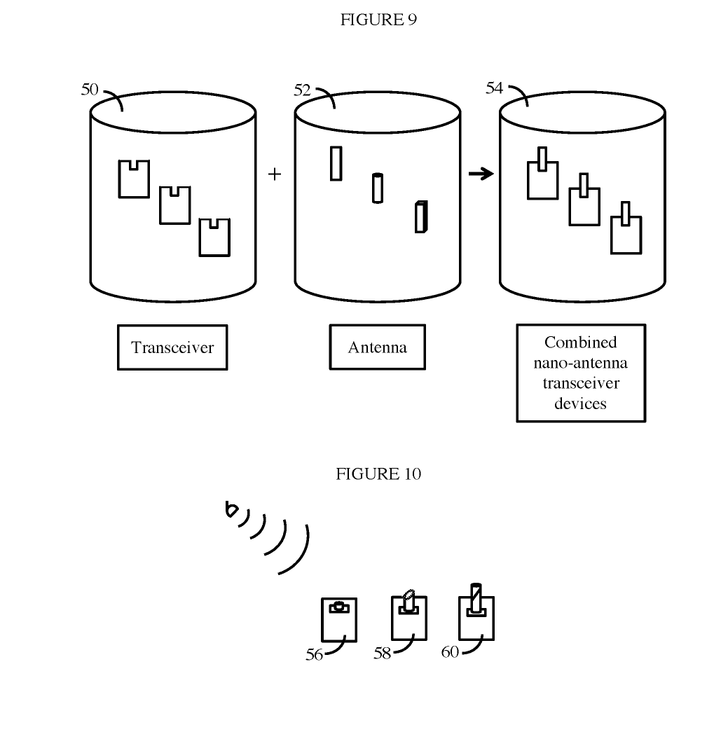

Referring to FIG. 10, transceiver with folded antenna 56 receives an external signal and initiates unfolding 58 into a final deployed position 60 with antenna fully extended.

Since the assembled devices have overall dimensions in the micrometer or nanometer scale, deployment may be effected by a multitude on means wherein the devices are exposed to host surfaces or fluids.

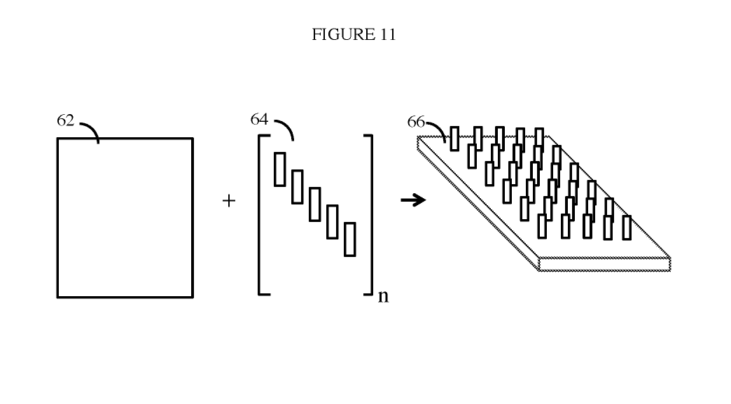

Referring to FIG. 11, a transceiver 62 with a prepared substrate surface is combined with a plurality of antennas 64 to produce a transceiver having multiple antennas 66.

Multiple antennas on a single substrate can also provide detection, reception, and transmission capabilities that vary compared to single node antenna devices.

As used herein, the term transceiver refers to a device comprising both a transmitter and a receiver which are combined and share common circuitry or a single housing.

When the transceiver and antenna are attached, communication may be called nano-communication, and would obey known variables, boundaries, rules, laws, and so forth, that apply to macro scale communication networks. Where metamaterials are employed, antenna attributed unique to those structures and devices. Nano scale antennas require communications in the terahertz band or near-infrared band of electromagnetic communication.

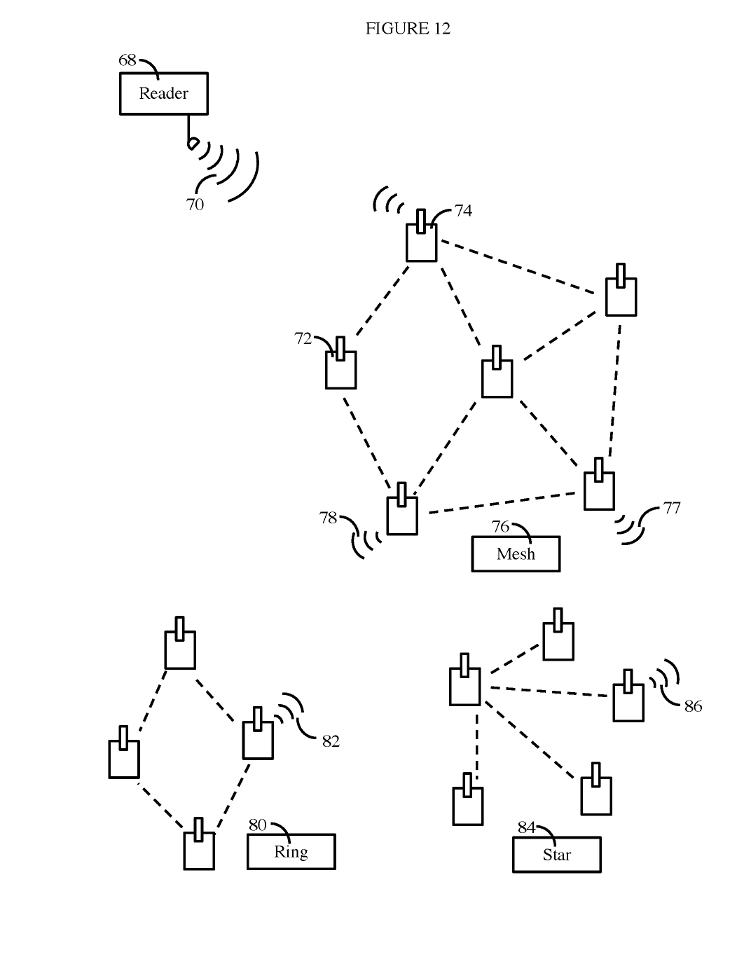

Referring now to FIG. 12, there is illustrated a reader 68 broadcasting a signal 70 to a mesh network 76 of nodes. Node 74 receives the signal and transmits a handshake acknowledgement while distributing the newly acquired data to nodes 72 and 78 in the mesh network 76. Mesh network 76 can then communicate/multiplex via the same or different frequency to another network, such as ring network 80 containing node 82. Node 77 of mesh network 76 communicates with star network 84 whereby an external signal 86 may be further broadcast.

Referring now to FIG. 8, there is illustrated a Reader 38 broadcasting signal 40 to be in communication with node 42 of a swarm network. Upon receipt, and verification that the entire querying signal was received, an acknowledgement 46 is sent by one or more nodes 46 back to reader 38. The data information is processed by the swarm 44, and additional information 46 can then be transmitted to the reader. Then, in sequence, the data is further transmitted to the swarm of nodes 48.

Network architectures, including swarms of transceiver-antenna devices, will necessarily include nodes, routers, interface devices, and gateways.

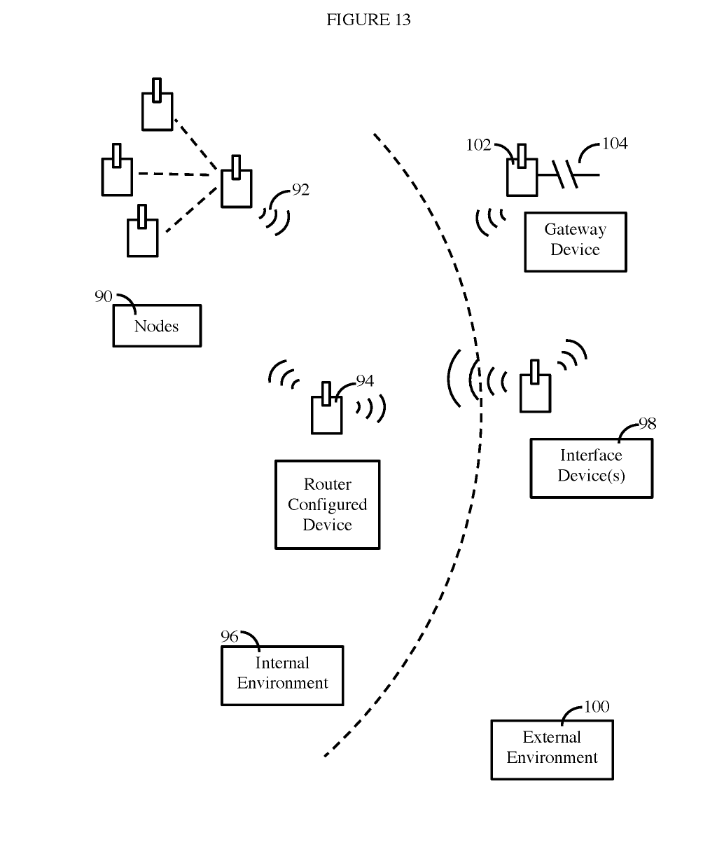

Referring now to FIG. 13, star network 90 broadcast signal 92 from their deployment within an internal environment 96. One of the nodes is configured as a router node 94 for communicating with an interface device node(s) 98, which may be located on the surface, e.g. as a patch, on the outer surface and facing the external environment 100. Interface device 98 communicates with gateway device 102, which may be in a wired or wireless connection with an outside network or computer 104.

Such a system could be used to monitor turbine fan blades with interior nodes on the surface of the blades communicating with a surface node patch, which is further linked by e.g. wifi to a monitoring station. A similar system is envisioned for monitoring the machinery, e.g. tires, or other items where wear is an issue. Medical monitoring is also contemplated where nodes would be interior by an organ, a latch on the skin communicates from the interior nodes to an exterior monitoring station.

For the signals and channel properties, it is contemplated that considerations of pathloss, noise, bandwidth and channel capacity, modulation/demodulation, compression/decompression, and encoding/decoding are within the scope of the invention. Further, modulation techniques and channel sharing/division techniques that use frequency, time, and codes, with or without orthogonality are contemplated as within the scope of the invention. It is also contemplated that each transceiver-antenna device will have its own MAC address.

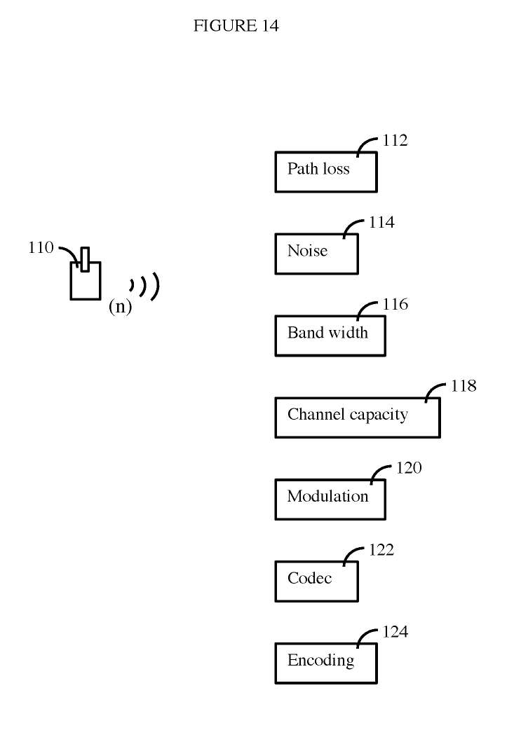

Referring now to FIG. 14, node(s) 110 alone or repeated in a mesh (n) are programmed individually or as a mesh, to monitor and mitigate pathloss 112, and noise 114. Transceiver of node 110 can also b programmed to receive and transmit one or more frequencies of bandwidth 116, and can be programmed to maximize channel capacity, provide modulated signals 120, provide compression and decompression 122, and optional encoding 124.

As used herein, a “nanowire” is an elongated nanoscale semiconductor which, at any point along its length, has at least one cross-sectional dimension and, in some embodiments, two orthogonal cross-sectional dimensions less than 50 nanometers, even more preferably less than 20 nanometers, still more preferably less than 10 nanometers, and even less than 5 nanometers. In other embodiments, the cross-sectional dimension can be less than 2 nanometers or 1 nanometer. In one set of embodiments the nanowire has at least one cross-sectional dimension ranging from 0.5 nanometers to 20 nanometers.

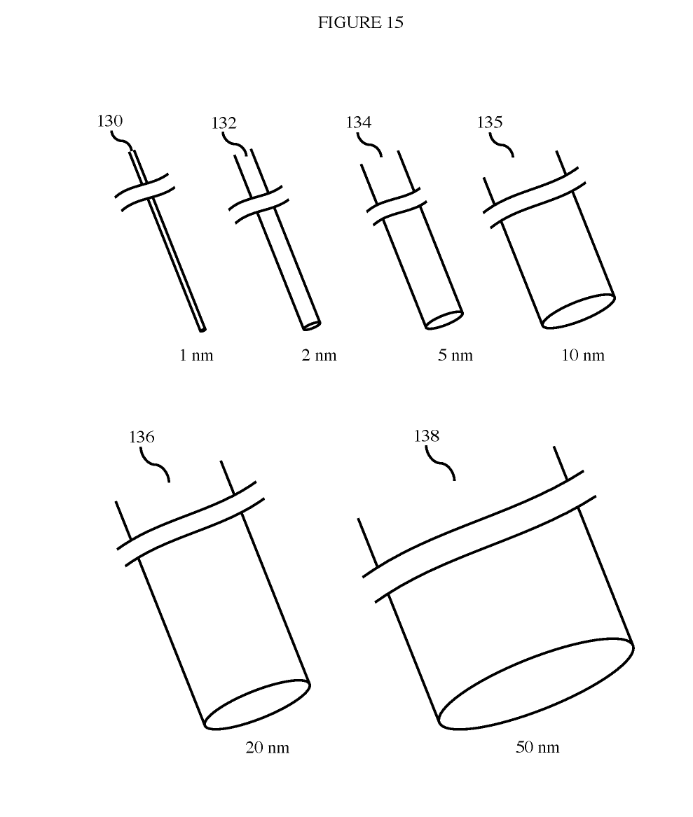

Referring now to FIG. 15, there is illustrated a 1 nm nanowire 130, a 2 nm nanowire 132, a 5 nm nanowire 134, a 10 nm nanowire 135, a 20 nm nanowire 136, and a 50 nm nanowire 138. (not to scale).

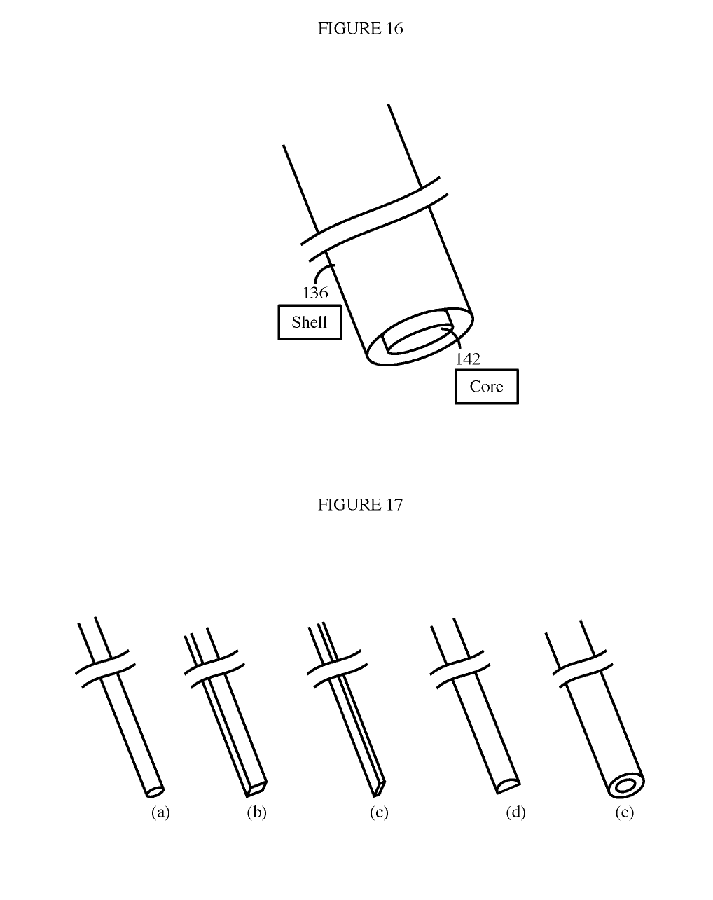

FIG. 16 illustrates a shell 140 and core 142 nanowire embodiment. Where nanowires are described having a core and an outer region, the above dimensions relate to those of the core.

FIG. 17 illustrates various geometries. The cross-section of the elongated semiconductor may have any arbitrary shape, including, but not limited to, circular 17(a), square 17(b), rectangular 17(c), elliptical 17(d) and tubular 17(e). Regular and irregular shapes are included. A non-limiting list of examples of materials from which nanowires of the invention can be made appears below. Nanotubes are a class of nanowires that find use in the invention and, in one embodiment, devices of the invention include wires of scale commensurate with nanotubes. As used herein, a “nanotube” is a nanowire that has a hollowed-out core, and includes those nanotubes know to those of ordinary skill in the art. A “wire” refers to any material having a conductivity at least that of a semiconductor or metal. For example, the term “electrically conductive” or a “conductor” or an “electrical conductor” when used with reference to a “conducting” wire or a nanowire refers to the ability of that wire to pass charge through itself. Preferred electrically conductive materials have a resistivity lower than about 10⁻³, more preferably lower than about 10⁻⁴, and most preferably lower than about 10⁻⁶ or 10⁻⁷ ohm-meters.

Such structures are on the order of 100 nm or less and are fabricated in a bottom-up or top-down approach. Bottom-up fabrication processes include the chemical synthesis, which enables the production of large numbers of nanoantennas in a range of sizes and shapes, including spheres, cubes, rods, octahedrons, triangular prisms, boxes, and stars. The synthesis may involve the reduction of metal salts by a chemical agent or by photochemical processes. Once the reduction is complete, further chemistry can be carried out including galvanic replacement reaction. Synthesized nanoantennas may be deposited on an antibody substrate.

Another process includes colloidal lithography, which is a bottom-up process, and enables the fabrication of periodic arrays of metal nanoantennas over a large area. In this fabrication technique, polymer nanospheres deposited on a substrate self-assemble into an ordered array creating a mask. The mask can be made up of one or more layers of particles. Metal is then evaporated onto the mask, filling the holes between the spheres, and when it is removed, an array of metallic nanoantennas remains on the substrate.

Top-down approaches differ from bottom-up methods because they do not involve chemical synthesis or self-assembly, and can be seen as an extension of microfabrication techniques. Deep ultraviolet projection lithography is a top-down approach that has been used to fabricate nanostructures. However in order to obtain metallic structures with dimensions on the order of 80 nm or less, processes that are not diffraction-limited are necessary. Focused ion beam and electron beam lithography are maskless sequential techniques that are widely used to fabricate nanostructures of different sizes or shapes very accurately on a substrate. Other processes such as soft and nanoinprint lithography have been developed and allow large numbers of complex nanostructures to be fabricated on a substrate at low cost with high accuracy using a mold made by electron beam lithography.

“Antibody” refers to a protein or glycoprotein consisting of one or more polypeptides substantially encoded by immunoglobulin genes or fragments of immunoglobulin genes. The recognized immunoglobulin genes include the kappa, lambda, alpha, gamma, delta, epsilon and mu constant region genes, as well as myriad immunoglobulin variable region genes. Light chains are classified as either kappa or lambda. Heavy chains are classified as gamma, mu, alpha, delta, or epsilon, which in turn define the immunoglobulin classes, IgG, IgM, IgA, IgD and IgE, respectively. A typical immunoglobulin (antibody) structural unit is known to comprise a tetramer. Each tetramer is composed of two identical pairs of polypeptide chains, each pair having one “light” (about 25 kD) and one “heavy” chain (about 50-70 kD). The N-terminus of each chain defines a variable region of about 100 to 110 or more amino acids primarily responsible for antigen recognition. The terms variable light chain (VL) and variable heavy chain (VH) refer to these light and heavy chains respectively.

Antibodies exist as intact immunoglobulins or as a number of well characterized fragments produced by digestion with various peptidases. Thus, for example, pepsin digests an antibody below (i.e. toward the Fc domain) the disulfide linkages in the hinge region to produce F(ab)′2, a dimer of Fab which itself is a light chain joined to VH-CH1 by a disulfide bond. The F(ab)′2 may be reduced under mild conditions to break the disulfide linkage in the hinge region thereby converting the (Fab′)2 dimer into an Fab′ monomer. The Fab′ monomer is essentially a Fab with part of the hinge region (see, Paul (1993) Fundamental Immunology, Raven Press, N.Y. for a more detailed description of other antibody fragments). While various antibody fragments are defined in terms of the digestion of an intact antibody, one of skill will appreciate that such fragments may be synthesized de novo either chemically, by utilizing recombinant DNA methodology, or by “phage display” methods (see, e.g., Vaughan et al. (1996) Nature Biotechnology, 14(3): 309-314, and PCT/US96/10287). Preferred antibodies include single chain antibodies, e.g., single chain Fv (scFv) antibodies in which a variable heavy and a variable light chain are joined together (directly or through a peptide linker) to form a continuous polypeptide.

The term “fluid” is defined as a substance that tends to flow and to conform to the outline of its container: Typically fluids are materials that are unable to withstand a static shear stress. When a shear stress is applied to a fluid it experiences a continuing and permanent distortion. Typical fluids include liquids and gases, but may also include free flowing solid particles.

The term “sample” refers to any cell, tissue, or fluid from a biological source (a “biological sample”), or any other medium, biological or non-biological, that can be evaluated in accordance with the invention including, such as serum or water. A sample includes, but is not limited to, a biological sample drawn from an organism (e.g. a human, a non-human mammal, an invertebrate, a plant, a fungus, an algae, a bacteria, a virus, etc.), a sample drawn from food designed for human consumption, a sample including food designed for animal consumption such as livestock feed, milk, an organ donation sample, a sample of blood destined for a blood supply, a sample from a water supply, or the like.

The term “binding” refers to a reaction between an antibody and antigen in a fluid or mixture of heterogeneous molecules (e.g., proteins and other biologics). Thus, for example, in the case of an antibody it would specifically bind to its antigen.

The invention also contemplates authentication aspects. For example, metamaterials that are thermo-, magneto-, electro-, electromagneto-, chemo-sensitive metamaterials may be used. Additionally, metamaterials that are multilayer time domain and up/down converting metamaterials may also be included as multimodal authentication (MMA) motifs.

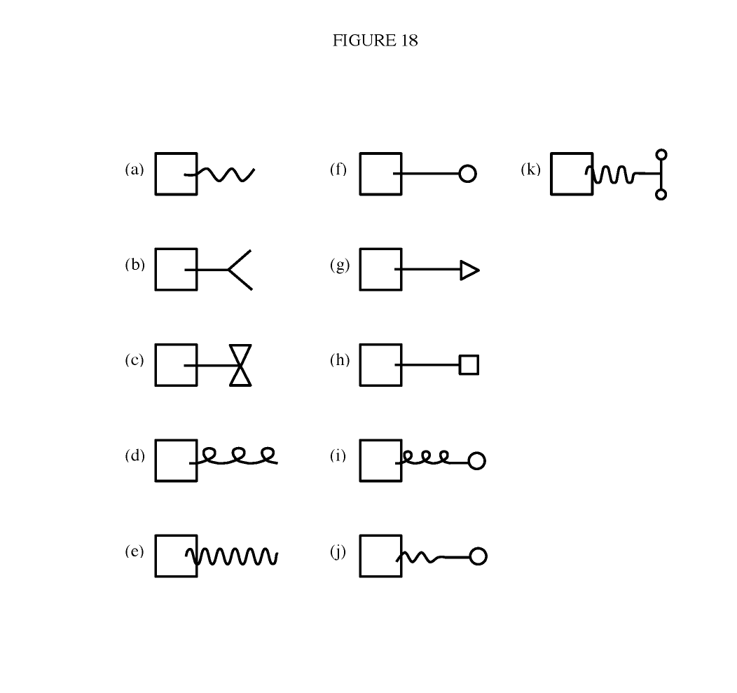

Referring now to FIG. 18, there is illustrated a variety of antenna attached to node transceivers, as follows: (a) a meander antenna; (b) dipole; (c) bowtie; (d) helical; (e) coil; (f) capacitative endcap; (g) triangular capacitative endcap; (h) square capacitative endcap; (i) combination inductive helical attachment with straight mid-section antenna and capacitative endcap; (j) combination inductive coil attachment with straight mid-section antenna and capacitative endcap; and (k) combination inductive meander attachment to transceiver with straight mid-section antenna and capacitative endcap in a dipole configuration.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

Having described embodiments for the invention herein, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

What is claimed:

1. A micro or nano electromagnetic radiation transceiver comprising circuitry to sense and react to the electromagnetic radiation, and antenna of dimensions similar to the transceiver, and circuitry to communicate with similarly configured transceivers.

2. A swarm of devices to cooperatively sense electromagnetic radiation and constructed with individual dimensions approaching or less the wavelength of the radiation, in particular, device(s) with antennas sensing radiation which have a critical dimension ranging from ½ to 1/100 the wavelength of the radiation.

3. A nano electromagnetic radiation transceiver comprising circuitry to sense and react to the electromagnetic radiation, a nano antenna of dimensions similar to the transceiver, an antibody attached to the transceiver, and an antigen specific to the antibody attached to the nano antenna, wherein the transceiver and antenna are attached using antibody-antigen binding, and circuitry to communicate with similarly configured transceivers.

4. A network of devices according to claim 3.

5. A micro or nano electromagnetic radiation transceiver comprising circuitry to sense and react to the electromagnetic radiation comprising antenna(s) incorporating metamaterials.

6. Antenna comprising metamaterials responsive to electromagnetic radiation in the near infrared or terahertz regions which have critical dimensions ½ to 1/100 the wavelength of the radiation.
